(19) United States
(12) Patent Application Publication
(10) Pub. No.: US 2013/0258257 A1
(43) Pub. Date: Oct. 3, 2013

(54) Liquid Crystal Display Panel, Method for Making the Panel, and Liquid Crystal Display Device

(71) Applicants: Ming Liu, Shenzhen (CN); Tao Ding, Shenzhen (CN); Guo Zhao, Shenzhen (CN)

(72) Inventors: Ming Liu, Shenzhen (CN); Tao Ding, Shenzhen (CN); Guo Zhao, Shenzhen (CN)

(73) Assignee: SHENZHEN CHINA STAR OPTOELECTRONICS TECHNOLOGY CO LTD., Shenzhen (CN)

(21) Appl. No.: 13/574,617

(22) PCT Filed: Apr. 25, 2012
(86) PCT No.: PCT/CN12/74635

§ 371 Date: Jul. 22, 2012

(30) Foreign Application Priority Data
Mar. 28, 2012 (CN) 201210086518.2

(51) Int. Cl. G02F 1/1339; H01J 9/26

(52) U.S. Cl. 349/106; 445/25

(57) ABSTRACT

The present invention provides a liquid crystal display panel, a method for making the panel, and a liquid crystal display device. The liquid crystal display panel includes a color filter substrate and a thin-film-transistor substrate facing each other. Wherein the thin-film-transistor includes a transfer pad, a first alignment film, and a sealant deploying area. The sealant is arranged between the color filter substrate and the thin-film-transistor substrate and is located at outside of a displaying area of the liquid crystal display panel. The thin-film-transistor includes a transfer pad arranged close to an outer rim of a displaying area and located on an inner surface of the thin-film-transistor substrate. The first alignment film is disposed over a surface of the thin-film-transistor substrate and covering the transfer pad; and a sealant deploying area is arranged on the thin-film-transistor substrate, and wherein an edge of the sealant deploying area is located outside of the displaying area of the liquid crystal display panel, wherein the sealant deploying area is partially arranged on the first alignment film. The distance between the edge of the displaying area of the LCD panel to the cutting edge of the LCD panel is tremendously shortened. Accordingly, by the provision of the present invention, the purpose of providing and designing a narrow-border LCD panel is readily achieved. The customer can readily appreciate the improvement provided by the present invention.

### FIELD OF THE INVENTION

The present invention relates to a technical field of liquid crystal display, and more particularly to a liquid crystal display panel, a method for making the panel, and a liquid crystal display device.

Thin Film Transistor Liquid Crystal Display, aka TFT-LCD has become the main stream of the panel display market. Recently, the TFT-LCD with narrow borders has also been widely requested from the customers.

In the existing TFT-LCD, a transfer pad is a requisite part as it functions a bridge to both the TFT substrate and CF (color filter) substrate. Once the TFT substrate and the CF substrate are energized, the crystal filled therein is also energized the electrical field created.

Referring to FIG. 1, a typical and illustrational view of a conventional liquid crystal display panel. As shown, a border of the alignment film 11 is located on an area outside of the border of the displaying area 12. A sealant deploy area 13 and the transfer pad 14 are arranged in an area located between an outer side of an edge of the alignment film 11 and a cutting edge 15 of the liquid crystal display panel.

For example, in a typical 32 inches display panel, in the current design, a distance between the center of the transfer pad 14 and the displaying area 12 of the LCD along the horizontal direction is L1, and it is about 4.3 mm. A distance between the center of the transfer pad 14, and the cutting edge 15 of the LCD along the horizontal direction L2 is about 1.5 mm. Accordingly, the width L3 of the border of the LCD equals to the sum of L1+L2, which equals to 5.8 mm.

Apparently, since the transfer pad 14 is located in an area outside of the alignment film 11, it inevitably increases the border of the LCD panel, up to 6 mm. And this is really detrimental to the trend of a LCD with narrow-border.

Accordingly, there is a necessity for a LCD panel with narrowed border, a method for making it, and a LCD device made from such a LCD panel.

### SUMMARY OF THE INVENTION

It is an object of the present invention to provide a LCD panel along with a method to make it so as to reduce the border of the LCD panel. The present invention also includes a LCD device incorporated with such a LCD panel.

In order to resolve the prior art issue, the present invention provides a technologic solution of which a liquid crystal display panel is provided, and the panel includes a color filter substrate and a thin-film-transistor substrate facing each other. A sealant is arranged between the color filter substrate and the thin-film-transistor substrate so as to securely bind the color filter substrate and the thin-film-transistor substrate together, wherein the sealant is located at outside of a displaying area of the liquid crystal display panel. The thin-film-transistor includes a transfer pad arranged close to an outer rim of a displaying area and located on an inner surface of the thin-film-transistor substrate. A first alignment film is disposed over a surface of the thin-film-transistor substrate and covering the transfer pad; and a sealant deploying area arranged on the thin-film-transistor substrate, and wherein an edge of the sealant deploying area is located outside of the displaying area of the liquid crystal display panel, and wherein the sealant deploying area and the transfer pad are located in an area located between the edge of the displaying area and the edge of the first alignment film.

Wherein the sealant deploying area is arranged with a lot of metallic balls.

Wherein the color filter is provided with a common electrode and a second alignment film in sequence in an inner surface thereof, wherein the second alignment film is overlapped over the common electrode, wherein after the assembly of the color filter substrate and the thin-film-transistor substrate, the transfer pad is electrically interconnected with the common electrode of the color filter substrate by those metallic balls penetrating though the first alignment film.

Wherein the color filter is provided with a common electrode and a second alignment film in sequence in an inner surface thereof, wherein the second alignment film is overlapped over the common electrode, wherein after the assembly of the color filter substrate and the thin-film-transistor substrate, the transfer pad is electrically interconnected with the common electrode of the color filter substrate by those metallic balls penetrating though the first alignment film and the second alignment film.

Wherein the metallic balls are golden balls or silver balls.

Wherein the metallic balls have spikes.

In order to resolve the prior art issue, the present invention provides a technologic solution of which a liquid crystal device is provided. The liquid crystal display device includes a liquid crystal display panel and a backlight module which provides illumination to the liquid crystal display panel. Wherein the liquid crystal display panel includes a color filter substrate and a thin-film-transistor substrate lacing each other. A sealant is arranged between the color filter substrate and the thin-film-transistor substrate so as to securely bind the color filter substrate and the thin-film-transistor substrate together, wherein the sealant is located at outside of a displaying area of the liquid crystal display panel. The thin-film-transistor includes a transfer pad arranged close to an outer rim of a displaying area and located on an inner surface of the thin-film-transistor substrate. A first alignment film is disposed over a surface of the thin-film-transistor substrate and covering the transfer pad; and a sealant deploying area is arranged on the thin-film-transistor substrate, and wherein an edge of the sealant deploying area is located outside of the displaying area of the liquid crystal display panel, wherein the sealant deploying area is partially arranged on the first alignment film.

Wherein the sealant deploying area and the transfer pad are located in an area located between the edge of the displaying area and the edge of the first alignment film.

Wherein the sealant deploying area is arranged with a lot of metallic balls.

Wherein the color filter is provided with a common electrode and a second alignment film in sequence in an inner surface thereof, wherein the second alignment film is overlapped over the common electrode, wherein after the assembly of the color filter substrate and the thin-film-transistor substrate, the transfer pad is electrically interconnected with the common electrode of the color filter substrate by those metallic balls penetrating though the first alignment film.

Wherein the color filter is provided with a common electrode and a second alignment film in sequence in an inner surface thereof, wherein the second alignment film is overlapped over the common electrode, wherein after the assembly of the color filter substrate and the thin-film-transistor substrate, the transfer pad is electrically interconnected with the common electrode of the color filter substrate by those metallic balls penetrating though the first alignment film and the second alignment film.

Wherein the metallic balls are golden balls or silver balls.

Wherein the metallic balls have spikes.

In order to resolve the prior art issue, the present invention provides another technologic solution in which a method for making liquid crystal display panel is introduced.

a) providing a first substrate and depositing at least a transfer pad on the first substrate;

b) deploying a first alignment film on a first alignment film area of the first alignment film and covering the transfer pad with the first alignment film;

c) blending a plurality of metallic balls into a sealant, and then deploying the sealant over the first alignment film, wherein an edge of a sealant deploying area is located outside of a displaying area of the liquid crystal display panel, and wherein the sealant deploying area is partially disposed on the first alignment film;

d) providing a second substrate, and deploying a second alignment film over the second substrate; and

e) assembling of the first and second substrates.

Wherein the first substrate is a thin-film-transistor substrate, and the second substrate is a color film substrate, and wherein the transfer pad and the sealant deploying area are located in an area located between the edge of the displaying area and the edge of the first alignment film.

The present invention can be concluded with the following advantages. As compared to the prior art, in the liquid crystal display panel, a method for making the panel, and a liquid crystal display device provided by the present invention, with the relocation of the transfer pad and the deploying area of the sealant inward to the first alignment film, such that the first alignment film covers the transfer pad, and the deploying area of the sealant is partially over the first alignment film, the distance between the edge of the displaying area of the LCD panel to the cutting edge of the LCD panel is tremendously shortened. As a result, the border is narrowed impressively as compared with the prior art. Accordingly, by the provision of the present invention, the purpose of providing and designing a narrow-border LCD panel is readily achieved. The customer can readily appreciate the improvement provided by the present invention.

### BRIEF DESCRIPTION OF DRAWINGS

In order to give a better and thorough understanding to the whole and other intended purposes, features and advantages of the technical solution of the present invention, detailed description will be given with respect to preferred embodiments provided and illustrated herebelow in accompanied drawings. Apparently, with the spirit of the embodiments disclosed, person in the skilled in the art can readily come out with other modifications as well as improvements without undue experiment. In addition, other drawings can be readily achieved based on the disclosed drawings. Wherein

FIG. 1 is a typical and illustrational view of a prior art liquid crystal display panel;

FIG. 2 is an illustrational view of a liquid crystal display panel made in accordance with a first embodiment of the present invention;

FIG. 3 is a cross sectional view of the liquid crystal display of the first embodiment taken along line 11 of FIG. 2;

FIG. 4 is a microscopic photo showing a metal ball penetrating through an alignment film;

FIG. 5 is a skeptic view showing the coined prints of the alignment film penetrated by the metal ball;

FIG. 6 is an illustrational view of a liquid crystal display panel made in accordance with a second embodiment of the present invention;

FIG. 7 is a flow diagrams showing the steps used to make the liquid crystal display in accordance with the present invention; and

FIG. 8 is an illustrational view of a liquid crystal display device made in accordance with the present invention.

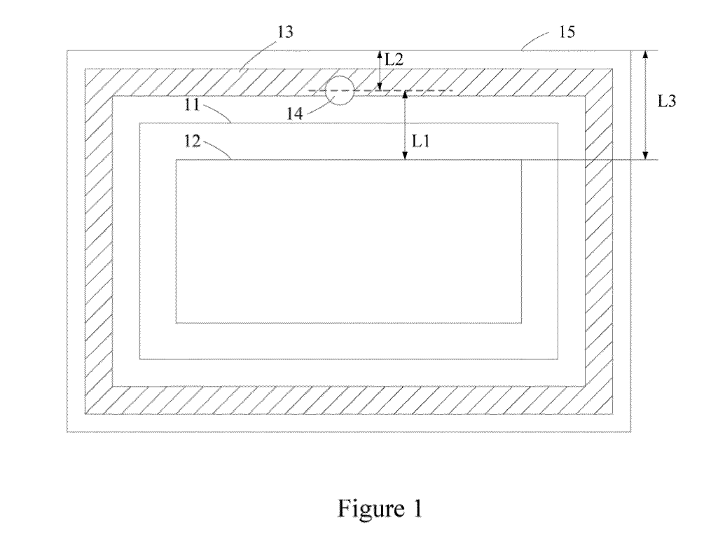

### DETAILED DESCRIPTION OF PREFERRED EMBODIMENTS

The purpose of the present invention is to provide a narrow-border liquid crystal display panel and a liquid crystal display device incorporated with such a panel.

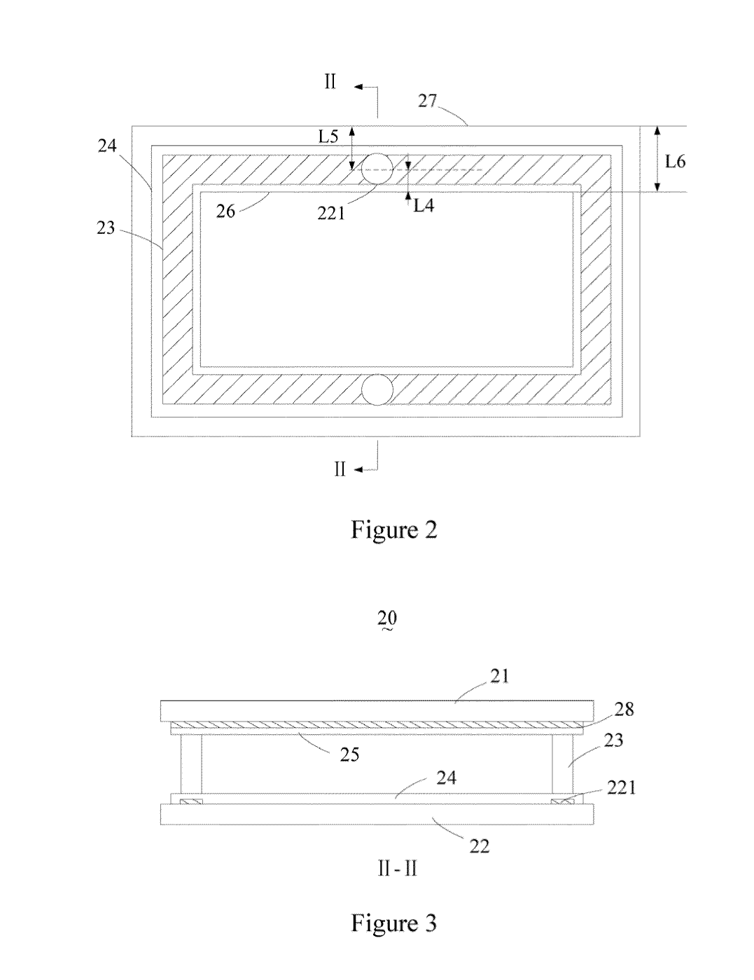

FIG. 2 is an illustrational view of a liquid crystal display panel made in accordance with a first embodiment of the present invention; and FIG. 3 is a cross sectional view of the liquid crystal display of the first embodiment taken along line II of FIG. 2.

Referring jointly to FIGS. 2 and 3, a liquid crystal display panel 20 made in according to a first embodiment of the present invention includes a color filter substrate 21, a TFT substrate 22 opposite to the color filter substrate 21, a sealant 23, a first alignment film 24, a second alignment film 25, and a liquid crystal (not shown in Figure) filled between the color film substrate 21, the TFT substrate 22 and the sealant 23.

In the current embodiment, the sealant 23 is dispensed between the color filter substrate 21 and the TFT substrate 22 so as to have both compactly stacked together. The sealant 23 is blended with a plurality of micro metallic balls (not shown in Figure).

The microscopic metallic balls are made from microscopic polymer balls coated with a metallic layer. The diameter of the metallic balls is selected from a gap between the color filter substrate 21 and the TFT substrate 22 divided with a compression rate of the metallic ball. The compression rate of the metallic ball is 0.88. The metallic layer is preferably selected from gold. However, the skilled in the art can readily make other selection, such as a silver ball.

In the first embodiment, the first alignment film 24 is disposed on an inner surface of the TFT substrate 22. The inner surface of the TFT substrate 22 is a surface in which a driving circuit is provided.

The second alignment film 25, the common electrode 28 are arranged on the inner surface of the color filter substrate 21. The inner surface is meant to be a surface of the color filter substrate 21 in which color filter is arranged.

The thickness of the first and second alignment films 24 and 25 are one thousand Angstrom (1000 Å).

It should be understood that the liquid crystal display panel 20 disclosed by the present invention also include a color filter and other components on the color filter substrate 21. In addition, the TFT substrate 22 is further arranged with data lines, scanning lines, TFT switches, and pixels and other circuits used to drive the liquid crystal display panel 20. However, since the color filter substrate 21, the TFT substrate 22 of the liquid crystal display panel 20 are not the topic of the present invention, and which can be readily understood from the existing prior arts. As a result, not detailed description is given.

The structure of the liquid crystal display panel 20 made in accordance with the present invention is illustrated in FIG. 2. FIG. 2 illustrates the relative relationship and position of the displaying area, area for arranging alignment film, area for arranging the sealant 23, and the width of the cutting edge of the liquid crystal display panel 20.

In this preferred embodiment, the TFT substrate 22 includes a transfer pad 221 which is located right to the outer peripheral of the displaying area 26, and it is in an internal surface of the TFT substrate 22. The first alignment film 24 is also covered onto the transfer pad 221. The sealant 23 is deployed over the TFT substrate 22, and the sealant 23 is located on an outside peripheral of the displaying area 26.

In this embodiment, the transfer pad 221 and the sealant 23 are both located at the area between the outer peripheral of the displaying area 26 and the first alignment film 24. That is to say that the first alignment film 24 covers completely of the transfer pad 221, and the sealant 23 is completely arranged on the first alignment film 24. On the other hand, the second alignment film 25 is arranged on a common electrode 28 of the color filter substrate 21. The outer rim of the second alignment film 25 is located completely outside of the displaying area 26.

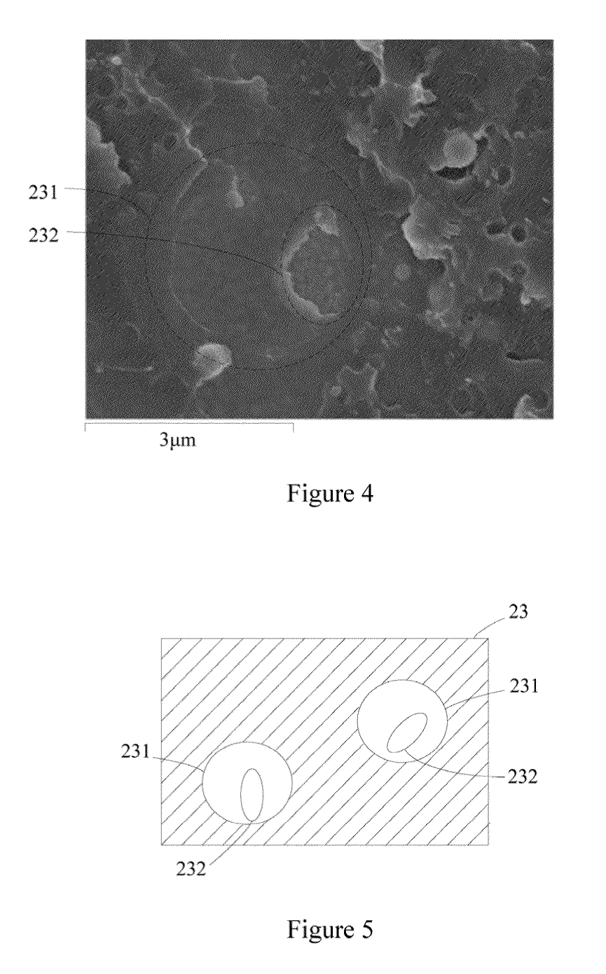

Referring now to FIGS. 4 to 5, FIG. 4 is a microscopic photo showing a metal ball penetrating through an alignment film; and FIG. 5 is a skeptic view showing the coined prints of the alignment film penetrated by the metal ball. When the alignment film is enlarged to cover the pixels of the transfer pad, and the metallic balls are deployed over the alignment film, then a test is conducted. As shown in FIG. 4, after the assembly of the CF substrate 21 and the TFT substrate 22, the metallic balls can penetrate the alignment film. That is to say that the transfer pad 221 can electrically interconnect to the common electrode 28 of the CF substrate 21 as the metallic balls penetrate through the first alignment film 24, the second alignment film 21. The coined print 231 is a trace showing the movement of the metallic balls on the sealant 23. The coined print 232 is a trace of the metallic ball on the first or second alignment films 24, 25.

The present invention will be further illustrated by an embodiment of a 32 inches LCD panel 20 and a transfer pad 221. In other embodiment, the more of the number of the transfer pad 221 deployed over the TFT substrate, the better the interconnections between the transfer pads 221 and the common electrode 28 of the CF substrate 21 can be achieved.

In the present embodiment, as shown in FIG. 2. the distance L4 between the center of the transfer pad 221 to the displaying area 26 of the LCD panel 20 on the same plane is about 1.7 mm. The distance L5 between the center of the transfer pad 221 to the cutting edge of the LCD panel 20 on the same plane is about 1.5 mm. Accordingly, the width L6 of the border of the LCD panel 20 equals to the sum of L4 plus L5, i.e. 3.2 mm.

As described above, as compared to the existing technology, the transfer pad 14 is located on the outside of the alignment film 11, while in the present embodiment, the transfer pad 221 and the sealant 23 are moved inland to area of the first alignment film 24 such that the transfer pad 221 is covered by the first alignment film 24, and then the sealant 23 is deployed over the first alignment film 24. By the arrangement, the width of the border of the LCD panel 20 is merely 3.2 mm, which is almost half (6 mm) of the prior art. With the advantages, the distance between the displaying area 26 of the LCD panel 20 to the cutting edge 27 of the LCD panel 20 is shortened. With this technology provided by the present invention, the LCD panel 20 with narrowed border can be readily achieved. The customer can readily appreciate the benefit from the present invention.

It should be understood that in other embodiments, the edge of second alignment film 25 can be readily relocated to the inner side of the sealant 23 by the skilled in the art. For example, the edge of the second alignment film 25 and the edge of the displaying area 26 are aligned with each other. The difference with the first embodiment is that, when the CF substrate 21 and the TFT substrate 22 are married together, the transfer pad 221 will make an electrical interconnection with the common electrode 28 of the CF substrate 21 by the metallic balls of the sealant 23 which penetrate the first alignment film 24.

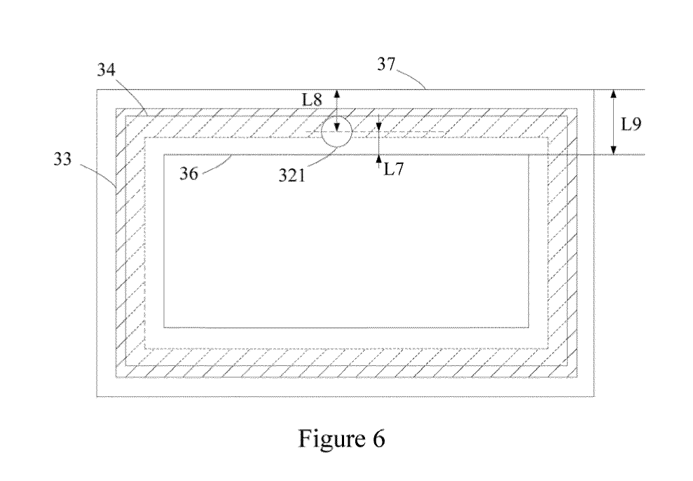

Referring to FIG. 6, which is an illustrational view of a liquid crystal display panel made in accordance with a second embodiment of the present invention. As shown in FIG. 6, the difference between the LCD panel of the second embodiment and the LCD panel 20 of the first embodiment resides on the sealant 33 is partially deployed on the first alignment film 34, i.e. the deploying area of the sealant 33 is partially overlapped with the first alignment film 34. The distance L7 between the center of the transfer pad 321 to the displaying area 36 of the LCD panel on the same plane is about 1.7 mm. The distance L8 between the center of the transfer pad 321 to the cutting edge 37 of the LCD panel on the same plane is about 1.5 mm. Accordingly, the width L9 of the border of the LCD panel equals to the sum of L4 plus L5, i.e. 3.2 mm, as illustrated below:

L9=L7+L8=32 mm

It should be noted that, interconnection rate between the transfer pad and the common electrode of the CF electrode can be readily increased with increasing the density of the metallic balls within the sealant 23 by the ordinary skilled in the art. In addition, in other embodiment, the metallic balls can be replaced with those metallic balls with pikes.

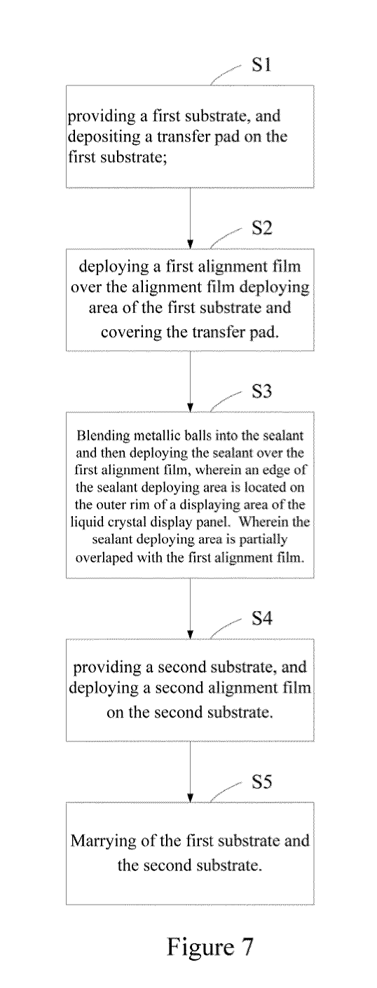

FIG. 7 is a flow diagrams showing the steps used to make the liquid crystal display in accordance with the present invention. The method includes the following steps.

Step S1: providing a first substrate, and depositing a transfer pad on the first substrate;

In the Step S1, the first substrate is a TFT substrate, and the transfer pad is located at outer rim of the displaying area of the LCD panel, and is arranged over the first alignment film. On the other hand, the first substrate can be further deployed with date lines, scanning lines, TFT switches, and pixels which are used to drive the LCD panel. Wherein the deposition of the transfer pad can be arranged simultaneously with the deployment of the TFT switches. However, the first substrate, the transfer pad is not within the scope of the present invention for improvement, as a result, and its manufacturing method can be readily referred to existing publications. As a result, no detailed description is given.

Step S2: deploying a first alignment film over the alignment area of the first substrate. In addition, the first alignment film is overlapped over the transfer pad.

Step S3: Blending metallic balls into the sealant and then deployed it over the first alignment film. Wherein the edge of the sealant deployed area is located at outside of the displaying area of the LCD panel. In addition, the sealant is partially overlapped over the first alignment film.

Step S4: providing a second substrate, and deploying a second alignment film on the second substrate.

In the step S4, the second alignment film can be partially deployed over the displaying area of the LCD panel, while it can be deployed only to the outside of the displaying area of the LCD panel.

Step S5: Assembling of the first substrate and the second substrate.

In the embodiment, the microscopic metallic balls are made from microscopic polymer balls coated with a metallic layer. Accordingly, the metallic ball exhibits a certain compression rate. After the assembly of the first substrate and the second substrate, the metallic balls can penetrate the first and second alignment films such that the first and second substrates are electrically interconnected.

The thickness of the first and second alignment films are preferably preset to one thousand Angstrom (1000 Å).

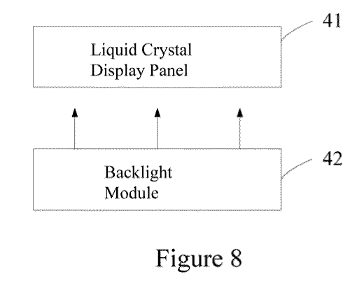

Furthermore, as shown in FIG. 8, the present invention provides a LCD device which includes a LCD panel 41 and a backlight module 42 which lights tip the LCD panel 41. The LCD panel 41 is selected from the panel made in according to the method illustrated above. As a result, not further description is given.

In conclusion, in the liquid crystal display panel, a method for making the panel, and a liquid crystal display device provided by the present invention, with the relocation of the transfer pad and the deploying area of the sealant inward to the first alignment film, such that the first alignment film covers the transfer pad, and the deploying area of the sealant is partially over the first alignment film, the distance between the edge of the displaying area of the LCD panel to the cutting edge of the LCD panel is tremendously shortened. As a result, the border is narrowed impressively as compared with the prior art. Accordingly, by the provision of the present invention, the purpose of providing and designing a narrow-border LCD panel is readily achieved. The customer can readily appreciate the improvement provided by the present invention.

Embodiments of the present invention have been described, but not intending to impose any unduly constraint to the appended claims. Any modification of equivalent structure or equivalent process made according to the disclosure and drawings of the present invention, or any application thereof, directly or indirectly, to other related fields of technique, is considered encompassed in the scope of protection defined by the clams of the present invention.

1. A liquid crystal display panel, wherein the liquid crystal display panel includes:
a color filter substrate and a thin-film-transistor substrate facing each other;
a sealant arranged between the color filter substrate and the thin-film-transistor substrate so as to securely bind the color filter substrate and the thin-film-transistor substrate together, wherein the sealant is located at outside of a displaying area of the liquid crystal display panel;
the thin-film-transistor including:
a transfer pad arranged close to an outer rim of a displaying area and located on an inner surface of the thin-film-transistor substrate;
a first alignment film disposed over a surface of the thin-film-transistor substrate and covering the transfer pad; and
a sealant deploying area arranged on the thin-film-transistor substrate, and wherein an edge_{.} of the sealant deploying area is located outside of the displaying area of the liquid crystal display panel, and wherein the sealant deploying area and the transfer pad are located in an area located between the edge of the displaying area and the edge of the first alignment film.

2. The liquid crystal display panel as recited in claim 1, wherein the sealant deploying area is arranged with a plurality of metallic balls.

3. The liquid crystal display panel as recited in claim 2, wherein the color filter is provided with a common electrode and a second alignment film in sequence in an inner surface thereof, wherein the second alignment film is overlapped over the common electrode, wherein after the assembly of the color filter substrate and the thin-film-transistor substrate, the transfer pad is electrically interconnected with the common electrode of the color filter substrate by those metallic balls penetrating though the first alignment film.

4. The liquid crystal display panel as recited in claim 2, wherein the color filter is provided with a common electrode and a second alignment film in sequence in an inner surface thereof, wherein the second alignment film is overlapped over the common electrode, wherein after the assembly of the color filter substrate and the thin-film-transistor substrate, the transfer pad is electrically interconnected with the common electrode of the color filter substrate by those metallic balls penetrating though the first alignment film and the second alignment film.

5. The liquid crystal display panel as recited in claim 2, wherein the metallic balls are golden balls or silver balls.

6. The liquid crystal display panel as recited in claim 5, herein the metallic balls have spikes.

7. A liquid crystal displaying device, the liquid crystal display device including: a liquid crystal display panel and a backlight module which provides illumination to the liquid crystal display panel, wherein the liquid crystal display panel includes:
a color filter substrate and a thin-film-transistor substrate facing each other;
a sealant arranged between the color filter substrate and the thin-film-transistor substrate so as to securely bind the color filter substrate and the thin-film-transistor substrate together, wherein the sealant is located at outside of a displaying area of the liquid crystal display panel;
the thin-film-transistor including:
a transfer pad arranged close to an outer rim of a displaying area and located on an inner surface of the thin-film-transistor substrate;
a first alignment film disposed over a surface of the thin-film-transistor substrate and covering the transfer pad; and
a sealant deploying area arranged on the thin-film-transistor substrate, and wherein an edge of the sealant deploying area is located outside of the displaying area of the liquid crystal display panel, wherein the sealant deploying area is partially arranged on the first alignment film.

8. The liquid crystal display device as recited in claim 7, wherein the sealant deploying area and the transfer pad are located in an area located between the edge of the displaying area and the edge of the first alignment film.

9. The liquid crystal display device as recited in claim 7. wherein the sealant deploying area is arranged with a plurality of metallic balls.

10. The liquid crystal display device as recited in claim 9, wherein the color filter is provided with a common electrode and a second alignment film in sequence in an inner surface thereof, wherein the second alignment film is overlapped over the common electrode, wherein after the assembly of the color filter substrate and the thin-film-transistor substrate, the transfer pad is electrically interconnected with the common electrode of the color filter substrate by those metallic balls penetrating though the first alignment film.

11. The liquid crystal display device as recited in claim 9, wherein the color filter is provided with a common electrode and a second alignment film in sequence in an inner surface thereof, wherein the second alignment film is overlapped over the common electrode, wherein after the assembly of the color filter substrate and the thin-film-transistor substrate, the transfer pad is electrically interconnected with the common electrode of the color filter substrate by those metallic balls penetrating though the first alignment film and the second alignment film.

12. The liquid crystal display device as recited in claim 9, wherein the metallic balls are golden balls or silver balls.

13. The liquid crystal display device as recited in claim 12, herein the metallic balls have spikes.

14. A method for making liquid crystal display panel, comprising the steps of:
a) providing a first substrate and depositing at least a transfer pad on the first substrate;
b) deploying a first alignment film on a first alignment film area of the first alignment film and covering the transfer pad with the first alignment film;
c) blending a plurality of metallic balls into a sealant, and then deploying the sealant over the first alignment film, wherein an edge of a sealant deploying area is located outside of a displaying area of the liquid crystal display panel, and wherein the sealant deploying area is partially disposed on the first alignment film;
d) providing a second substrate, and deploying a second alignment film over the second substrate; and
e) assembling of the first and second substrates.

15. The method as recited in claim 14, wherein the first substrate is a thin-film-transistor substrate, and the second substrate is a color film substrate, and wherein the transfer pad and the sealant deploying area are located in an area located between the edge of the displaying area and the edge of the first alignment film.
